(19) United States
(12) Patent Application Publication
(10) Pub. No.: US 2008/0178163 A1
(43) Pub. Date: Jul. 24, 2008

(54) Just-In-Time Compilation in a Heterogeneous Processing Environment

(76) Inventors: Michael Karl Gschwind, Chappaqua, NY (US); John Kevin Patrick O'Brien, South Salem, NY (US); Kathryn O'Brien, South Salem, NY (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 12/049,286

(22) Filed: Mar. 15, 2008

Related U.S. Application Data
(63) Continuation of application No. 11/421,503, filed on Jun. 1, 2006.

(51) Int. Cl. G06F 9/45

(52) U.S. Cl. 717/140

(57) ABSTRACT

An approach is provided that sends a JIT compilation request from a first process that is running on one processor to a JIT compiler that is running on another processor. The processors are based on different instruction set architectures (ISAs), and share a common memory to transfer data. Non-compiled statements are stored in the shared memory. The JIT compiler reads the non-compiled statements and compiles the statements into executable statements and stores them in the shared memory. The JIT compiler compiles the non-compiled statements destined for the first processor into executable instructions suitable for the first processor and statements destined for another type of processor (based on a different ISA) into instructions suitable for the other processor.

### RELATED APPLICATIONS

This application is a continuation application of co-pending U.S. Non-Provisional patent application Ser. No. 11/421,503, entitled “System and Method for Just-In-Time Compilation in a Heterogeneous Processing Environment,” filed on Jun. 1, 2006.

### BACKGROUND OF THE INVENTION

1. Technical Field

The present invention relates in general to a system and method for just-in-time compilation of software code. More particularly, the present invention relates to a system and method that advantageously uses heterogeneous processors and a shared memory to efficiently compile code.

2. Description of the Related Art

The Java language has rapidly been gaining importance as a standard object-oriented programming language since its advent in late 1995. Java source programs are first converted into an architecture-neutral distribution format, called “Java bytecode,” and the bytecode sequences are then interpreted by a Java virtual machine (JVM) for each platform. Although its platform-neutrality, flexibility, and reusability are all advantages for a programming language, the execution by interpretation imposes performance challenges.

One of the challenges faced is on account of the run-time overhead of the bytecode instruction fetch and decode. One means of improving the run-time performance is to use a just-in-time (JIT) compiler, which converts the given bytecode sequences “on the fly” into an equivalent sequence of the native code of the underlying machine. While using a JIT compiler significantly improves the program's performance, the overall program execution time, in contrast to that of a conventional static compiler, now includes the compilation overhead of the JIT compiler. A challenge, therefore, of using a JIT compiler is making the JIT compiler efficient, fast, and lightweight, as well as generating high-quality native code.

What is needed, therefore, is a system and method that performs Just-in-Time compilation in a heterogeneous processing environment, taking advantage of the strengths of different types of processors. Furthermore, what is needed is a system and method that can dynamically distribute the execution of the resulting compiled executable instructions on more than one processor selected from a group of heterogeneous processors.

### SUMMARY

It has been discovered that the aforementioned challenges are resolved using a system and method that sends a Just-in-Time (JIT) compilation request from a first process that is running on a first processor to a JIT compiler that is running on a second processor. The first and second processors are based on different instruction set architectures (ISAs), but they share a common memory to easily transfer data from one processor to the other. The non-compiled statements are stored in the shared memory. The JIT compiler reads the non-compiled statements from the shared memory and compiles the statements into executable statements which are also stored in the shared memory. If the first process is going to execute the statements, then the JIT compiler compiles the non-compiled statements into an executable format suitable for execution by the first processor. On the other hand, if some or all of the statements are going to be executed by a different process running on a different processor that uses a different ISA than the first processor, then the JIT compiler compiles the non-compiled statements into an executable format suitable for execution by the other processor.

In one embodiment, the JIT compiler creates more than one executable code segments. Some of these segments are executable by the first processor and some are executed by another processor that has a different ISA. In this embodiment, the JIT compiler inserts instructions in the code so that signals will be sent between the code segments in order to synchronize their execution.

In another embodiment, the first process encounters a larger section of un-compiled code and breaks the larger section into smaller sections that are executed by one of the processors. In this manner, execution does not have to wait until a larger code section is fully compiled before commencing execution. In addition, memory may be conserved by reclaiming memory of compiled sections that have already been executed before all of the sections have been executed. An alternative to this embodiment allows execution of some of the compiled sections by the first processor and execution of other sections by other processors that might have a different ISA than that used by the first processor.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram showing a Just-in-Time (JIT) compiler running on one processor type and supporting the JIT compilation needs of a process running on another processor type;

FIG. 2 is a diagram showing the JIT compiler delegating execution of some of the resulting executable instructions to another processor;

FIG. 3 is a diagram showing the JIT compiler blocking a large compilation request into sections and sequentially providing the compiled sections back to the requester;

FIG. 4 is a flowchart showing the steps taken by the JIT compiler;

FIG. 5 is a block diagram of a traditional information handling system in which the present invention can be implemented; and

FIG. 6 is a block diagram of a broadband engine that includes a plurality of heterogeneous processors in which the present invention can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

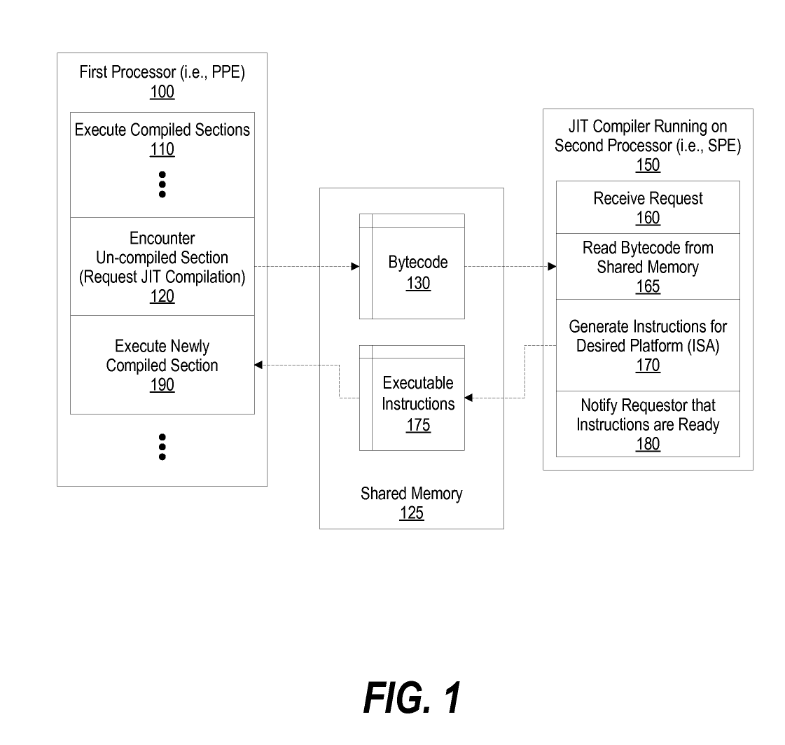

FIG. 1 is a block diagram showing a Just-in-Time (JIT) compiler running on one processor type and supporting the JIT compilation needs of a process running on another processor type. In the example shown, first processor 100 is executing a first process. In the first process, there can be compiled sections 110 that first processor 100 can readily execute. There can also be non-compiled statements, such as those encountered in un-compiled section 120. These non-compiled statements are frequently encountered when using a middleware environment, such as that used with a Java™ Virtual Machine (JVM). The advantage of using a middleware application is that non-compiled statements (in Java, these statements are called “Java bytecode”) are architecture neutral and can be executed by virtually any operating system that has a JVM. JIT compiler 150, runs on a separate processor that is based on a different Instruction Set Architecture (ISA) than first processor 100. In one embodiment, the JIT compiler runs on a synergistic processing element (SPE) that is a high-performance, SIMD (single instruction multiple data), reduced instruction set computing (RISC) processor. In this embodiment, the first processor is a general-purpose, primary processing element (PPE), such as a processor based on IBM's PowerPC™ design. One important feature is that both processors can access the same memory space (shared memory 125) even though the processors are based on different ISAs. The JIT compiler receives the compilation request at step 160. The shared memory space allows the JIT compiler to retrieve the non-compiled section of code (bytecode 130) from shared memory 125 (step 165). At step 170, the JIT compiler generates executable instructions based upon the desired platform where the instructions will be executed. In the example shown in FIG. 1, the desired platform is the PPE, so the instructions that are generated conform to the PPE's ISA. The executable instructions (175) are then stored in shared memory 125 and, at step 180, the JIT compiler notifies the requester that the un-compiled code section has been compiled and is ready for execution.

At step 190, when the process running on first processor 100 receives the notification that the executable instructions are ready, the process reads and executes executable instructions 175. The first process can continue to encounter un-compiled sections and receive and execute the compiled (executable) instructions as outlined above.

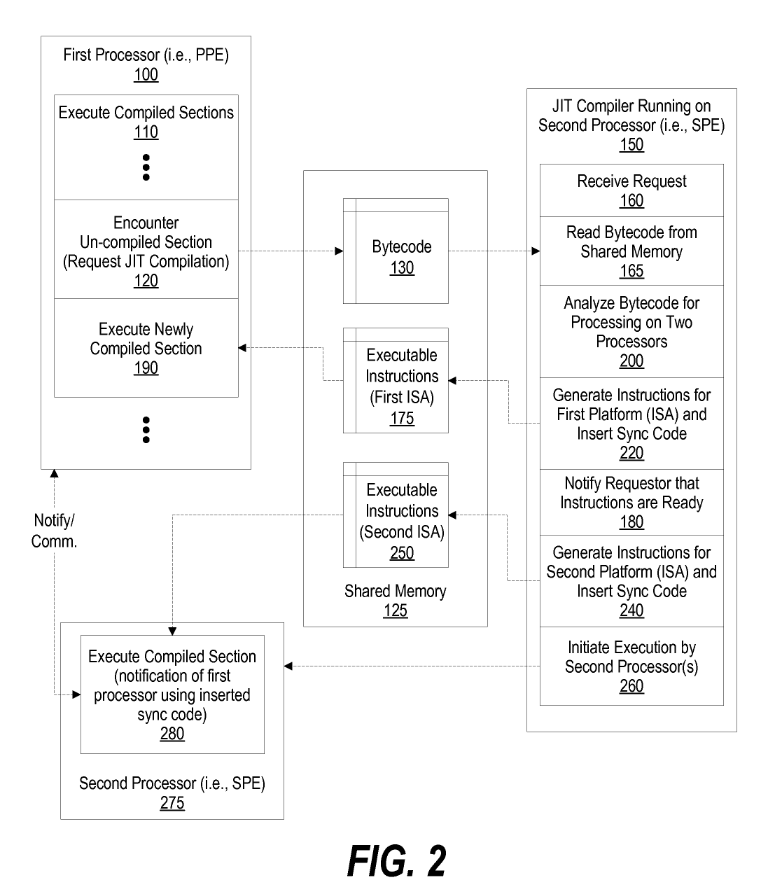

FIG. 2 is a diagram showing the JIT compiler delegating execution of some of the resulting executable instructions to another processor. FIG. 2 is an alternate embodiment from the embodiment shown in FIG. 1. In FIG. 2, the JIT compiler creates two sets of executable instructions—one set executable by first processor 100 (i.e., conforming to the first processor's ISA), and a second set executable by second processor 275 (i.e., conforming to the second processor's ISA which is different from the first processor's ISA). Some of the steps, such as receiving the request and reading the bytecode from shared memory, are the same as those shown in FIG. 1 and have the same reference numbers. For details regarding these steps, refer to the description provided in the description for FIG. 1.

For steps introduced in FIG. 2, at step 200, after the bytecode has been read from shared memory, the bytecode is analyzed for processing on two processors. In one embodiment this analysis is based upon statements in bytecode 130 that request execution on a particular type of processor is such processor type is available. In another embodiment, this analysis is based upon the processes and computations being performed by the bytecode. Some types of instruction sections may be better handled by first processor 100, while other types of instruction sections may be better handled by second processor 275, based on the characteristics of the particular processor types.

In any event, the result of the analysis will be two sets of instructions—one for each processor type. At step 220, the JIT compiler generates executable instructions 175 for execution by the first processor (i.e., that conform to the first processor's ISA) and includes synchronization code to synchronize the execution on the first and second processors. Executable instructions 175 are stored in shared memory 125. If most of the processing is being performed on the second processor, executable instructions 175 may be a small set of executable code that waits for a signal from second processor and retrieves any needed results prepared by second processor 275 from shared memory 125. At step 180, the JIT compiler sends a notification to the process running on the first processor informing the process that the instructions are ready for execution. At step 240, the JIT compiler generates instructions for the second processor's ISA (instructions 250) and inserts synchronization code. For example, the synchronization code may be to signal or otherwise notify the code running on the first processor. Generated instructions 250 are stored in shared memory 125. At step 260, the JIT compiler initiates execution of the instructions generated for the second ISA. In one embodiment, the processing element includes several SPEs. In this embodiment, one or more of the SPEs are selected to process executable instructions 250. At step 280, one or more second processors, such as SPEs, process executable instructions 250 by reading the instructions from shared memory 125 and executing them. While instructions for the first processor are shown being generated before the instructions for the second processor, the order of generation can be any order so that the instructions for the second processor can be generated and initiated on one of the second processors before generating the instructions for the first processor. Note also the “notify/comm.” signals between the first process running on the first processor and the second process running on the second processor. These notifications/communications can be through a mailbox subsystem, shared memory, or any other form of communications possible between the two processors.

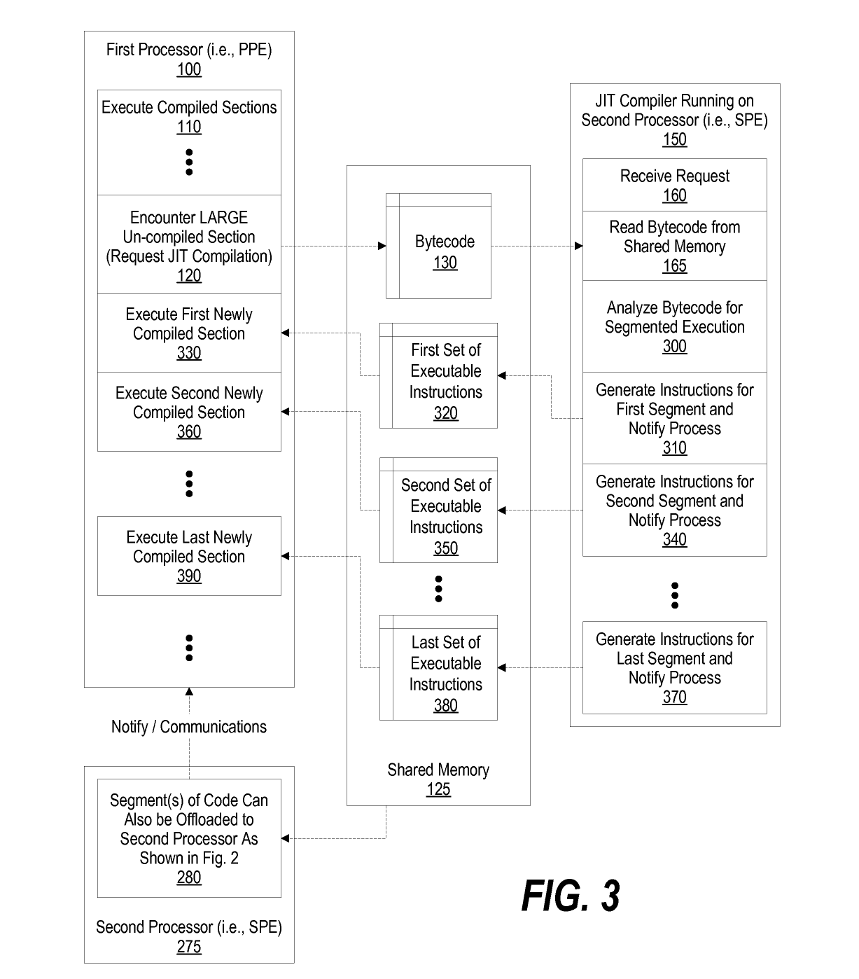

FIG. 3 is a diagram showing the JIT compiler blocking a large compilation request into sections and sequentially providing the compiled sections back to the requester. This figure is also similar to FIGS. 1 and 2 with a first process running on first processor 100 sending JIT compilation requests to JIT compiler 150 running on a different processor that is based upon a different ISA. In FIG. 3, the un-compiled section of code encountered by the first process at step 120 is a large segment of code, lending itself to be further segmented into separate sections that are separately compiled.

The JIT compiler receives the request and reads the bytecode from shared memory (step 160 and 165). For new steps introduced in FIG. 3, at step 300, the JIT compiler analyses the bytecode. During this analysis, the JIT compiler determines whether segmented execution should be used based on the size of the un-compiled bytecode. At step 320, instructions for the first segment are generated and stored in shared memory as first set of executable instructions 320. In addition, the JIT compiler notifies the process that the first segment is ready. At step 330, the process reads and executes the first set of compiled instructions. Similarly, at steps 340 and 370, the JIT compiler generates the second and last segments and compiles them to second set of executable instructions 350, and last set of executable instructions 380, respectively. After generating each of these segments, the JIT compiler notifies the process that the respective processes are ready for execution. At steps 360 and 390, respectively, the process receives the notifications and reads/executes the compiled instructions.

Combining the addition of one or more second processors 275, as described in more detail in FIG. 2, would allow some number of executable instruction segments to be executed on second processor 275. Notifications and other forms of communications would then be facilitated between the segments executed by second processor 275 and the segments executed by the process running on first processor 100.

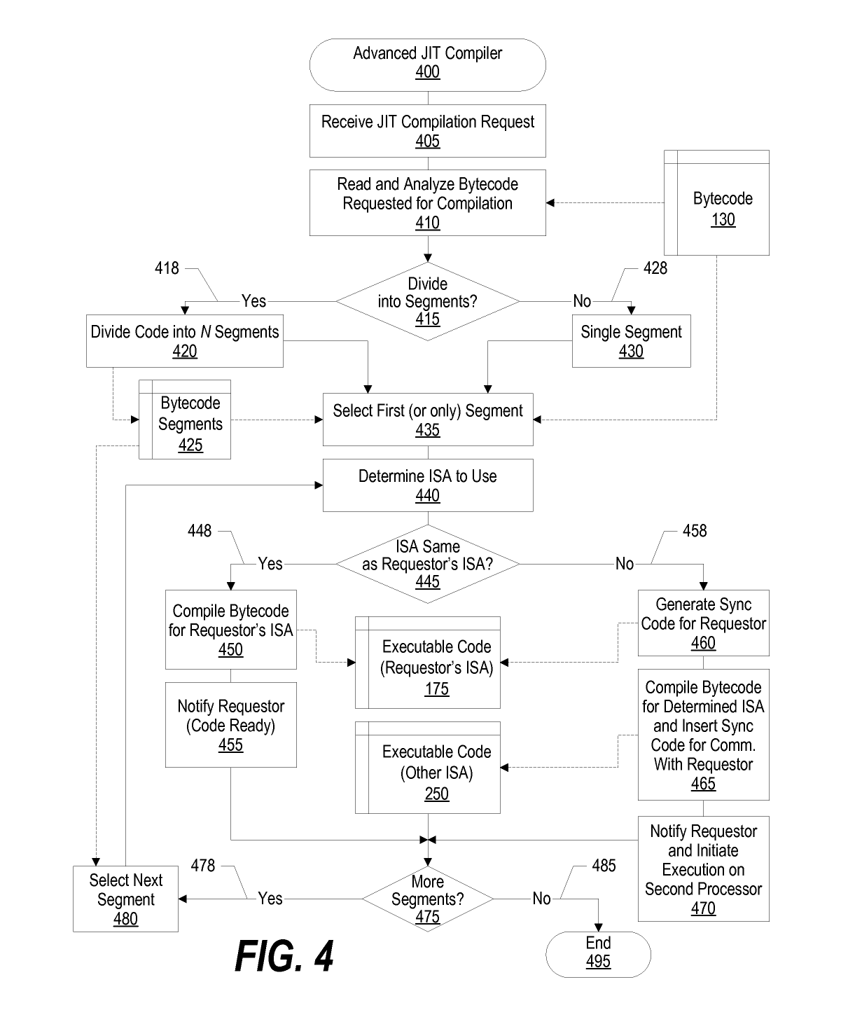

FIG. 4 is a flowchart showing the steps taken by the JIT compiler. Processing commences at 400 whereupon, at step 405, the JIT compiler receives the compilation request from a process running on a processor. The request corresponds to bytecode 130 that is stored in shared memory. At step 410, the JIT compiler reads and analyses some or all of the bytecode stored in the shared memory. The analysis determines whether the JIT compiler will divide the bytecode into multiple segments and compile the segments separately as well as which type of processor will execute the segments.

A determination is made as to whether to divide the bytecode into more than one segments (decision 415). In one embodiment, this determination is made based upon the size of bytecode as well as whether it is advantageous to execute some instructions on one type of processor and other instructions on a different type of processor (where there will be at least two segments—one with instructions complying with a first ISA and the other with instructions complying with a second ISA). If the bytecode is to be divided into more than one segment, decision 415 branches to “yes” branch 418 whereupon, at step 420, the bytecode is divided into the number of segments (bytecode segments 425) based on the analysis. On the other hand, if the bytecode is not to be divided, based on the analysis, decision 415 branches to “no” branch 428 whereupon a single segment (step 430) is used.

At step 435, the first segment is selected from bytecode segments 425, or if a single segment is being used, bytecode 130 is selected. At step 440, the ISA that will be used to execute the selected bytecode is determined. One way that this determination can be made is by including instructions in the bytecode requesting a particular ISA if such an ISA is available during execution. Another way that this determination can be made is by analyzing the types of computations and processes taking place in the selected bytecode and selecting the ISA that better handles the computations and processes. A determination is made as to whether the selected bytecode section is being generated with the same ISA as the requestor's ISA (decision 445). If the ISA is the same, then decision 445 branches to “yes” branch 448 whereupon, at step 450, the selected bytecode segment is compiled to an executable form (175) that complies with the requestor's ISA and, at step 455, the requester is notified that the code is ready for execution.

On the other hand, if the segment is being compiled to an executable form (250) that complies with a different ISA than that used by the requester, then decision 445 branches to “no” branch 458 to generate the executable code for both ISAs. At step 460, the JIT compiler generates synchronization code, such as notifications and other forms of communication, and stores the executable instructions that perform the synchronization in executable code 175. At step 465, the bytecode segment is compiled to comply with the selected ISA. In addition, synchronization code is inserted so that the code communicates with the code running by the requester. The executable code complying with the ISA that is not used by the requester is stored in the shared memory as executable code 250. At step 470, the JIT compiler notifies the requester that executable code 175 (containing the synchronization code) is ready for execution. In addition, execution of the other executable code (code 250) is initiated on a second processor that is different from the processor running the requester process.

A determination is made as to whether there are more segments to process (decision 475). If there are more segments to process, decision 475 branches to “yes” branch 478 whereupon, at step 480, the next segment from bytecode segments 425 is selected and processing loops back to process and compile the newly selected bytecode segment. This looping continues until all segments have been processed/compiled, at which point decision 475 branches to “no” branch 485 and processing ends at 495.

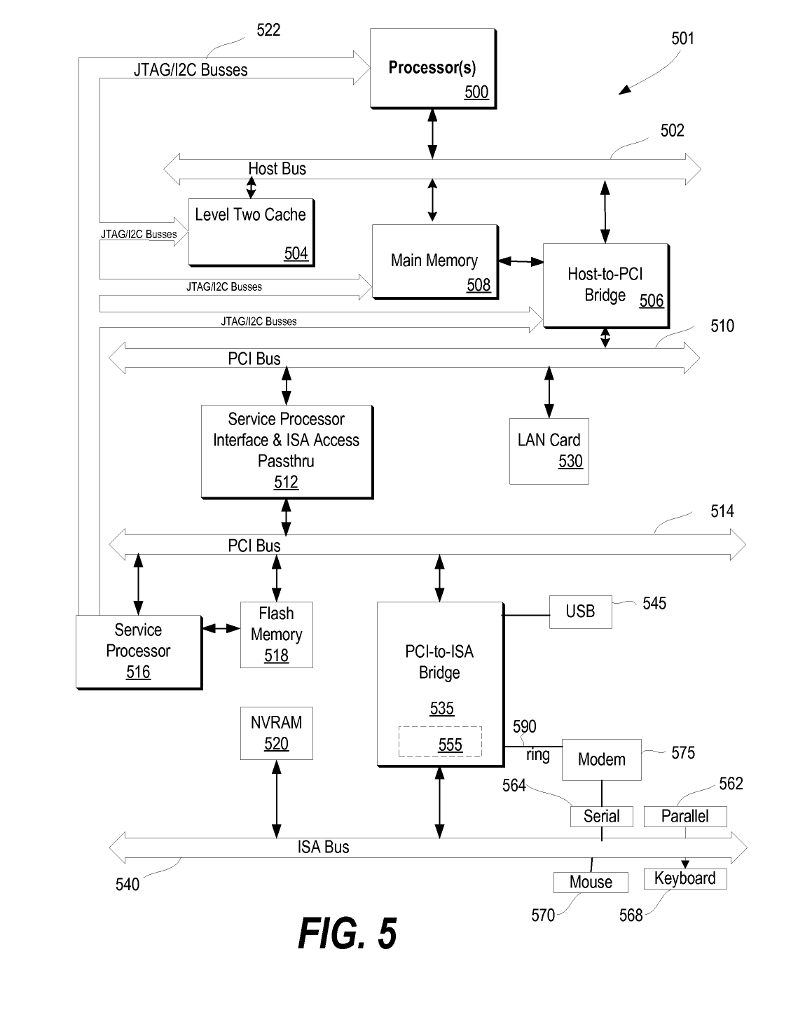

FIG. 5 illustrates information handling system 501 which is a simplified example of a computer system capable of performing the computing operations described herein. Computer system 501 includes processor 500 which is coupled to host bus 502. A level two (L2) cache memory 504 is also coupled to host bus 502. Host-to-PCI bridge 506 is coupled to main memory 508, includes cache memory and main memory control functions, and provides bus control to handle transfers among PCI bus 510, processor 500, L2 cache 504, main memory 508, and host bus 502. Main memory 508 is coupled to Host-to-PCI bridge 506 as well as host bus 502. Devices used solely by host processor(s) 500, such as LAN card 530, are coupled to PCI bus 510. Service Processor Interface and ISA Access Pass-through 512 provides an interface between PCI bus 510 and PCI bus 514. In this manner, PCI bus 514 is insulated from PCI bus 510. Devices, such as flash memory 518, are coupled to PCI bus 514. In one implementation, flash memory 518 includes BIOS code that incorporates the necessary processor executable code for a variety of low-level system functions and system boot functions.

PCI bus 514 provides an interface for a variety of devices that are shared by host processor(s) 500 and Service Processor 516 including, for example, flash memory 518. PCI-to-ISA bridge 535 provides bus control to handle transfers between PCI bus 514 and ISA bus 540, universal serial bus (USB) functionality 545, power management functionality 555, and can include other functional elements not shown, such as a real-time clock (RTC), DMA control, interrupt support, and system management bus support. Nonvolatile RAM 520 is attached to ISA Bus 540. Service Processor 516 includes JTAG and I2C busses 522 for communication with processor(s) 500 during initialization steps. JTAG/I2C busses 522 are also coupled to L2 cache 504, Host-to-PCI bridge 506, and main memory 508 providing a communications path between the processor, the Service Processor, the L2 cache, the Host-to-PCI bridge, and the main memory. Service Processor 516 also has access to system power resources for powering down information handling device 501.

Peripheral devices and input/output (I/O) devices can be attached to various interfaces (e.g., parallel interface 562, serial interface 564, keyboard interface 568, and mouse interface 570 coupled to ISA bus 540. Alternatively, many I/O devices can be accommodated by a super I/O controller (not shown) attached to ISA bus 540.

In order to attach computer system 501 to another computer system to copy files over a network, LAN card 530 is coupled to PCI bus 510. Similarly, to connect computer system 501 to an ISP to connect to the Internet using a telephone line connection, modem 575 is connected to serial port 564 and PCI-to-ISA Bridge 535.

While the computer system described in FIG. 5 is capable of executing the processes described herein, this computer system is simply one example of a computer system. Those skilled in the art will appreciate that many other computer system designs are capable of performing the processes described herein.

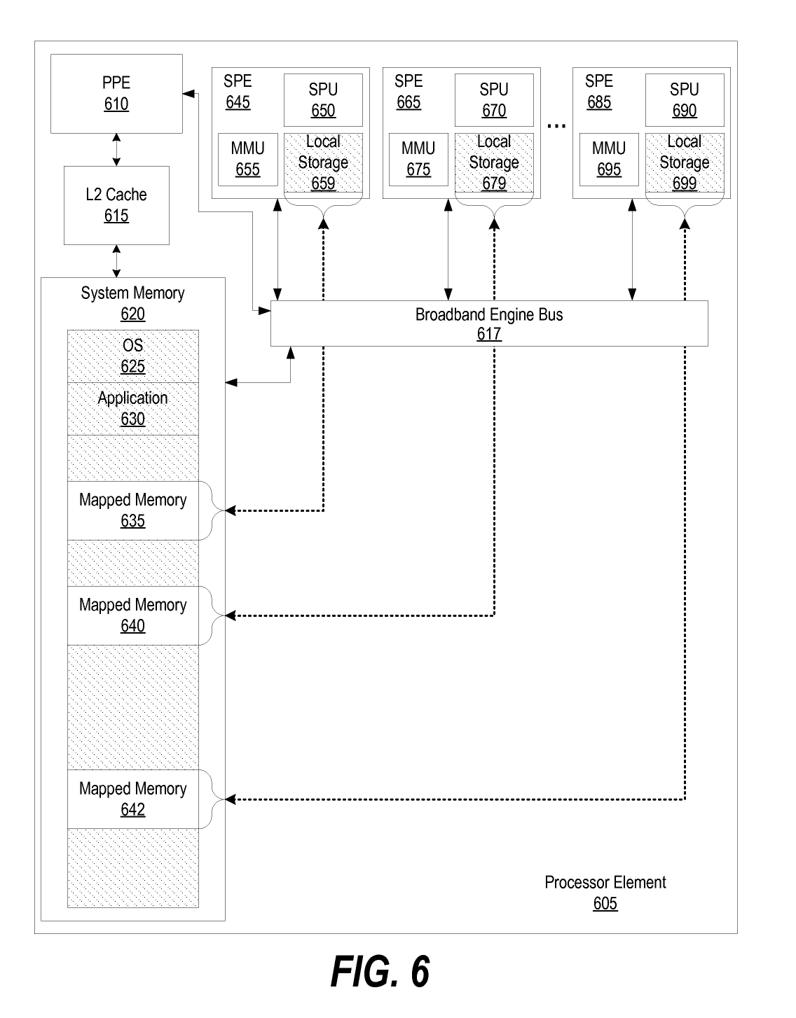

FIG. 6 is a block diagram illustrating a processing element having a main processor and a plurality of secondary processors sharing a system memory. FIG. 6 depicts a heterogeneous processing environment that can be used to implement the present invention. Primary Processor Element (PPE) 605 includes processing unit (PU) 610, which, in one embodiment, acts as the main processor and runs an operating system. Processing unit 610 may be, for example, a Power PC core executing a Linux operating system. PPE 605 also includes a plurality of synergistic processing elements (SPEs) such as SPEs 645, 665, and 685. The SPEs include synergistic processing units (SPUs) that act as secondary processing units to PU 610, a memory storage unit, and local storage. For example, SPE 645 includes SPU 660, MMU 655, and local storage 659; SPE 665 includes SPU 670, MMU 675, and local storage 679; and SPE 685 includes SPU 690, MMU 695, and local storage 699.

Each SPE may be configured to perform a different task, and accordingly, in one embodiment, each SPE may be accessed using different instruction sets. If PPE 605 is being used in a wireless communications system, for example, each SPE may be responsible for separate processing tasks, such as modulation, chip rate processing, encoding, network interfacing, etc. In another embodiment, the SPEs may have identical instruction sets and may be used in parallel with each other to perform operations benefiting from parallel processing.

PPE 605 may also include level 2 cache, such as L2 cache 615, for the use of PU 610. In addition, PPE 605 includes system memory 620, which is shared between PU 610 and the SPUs. System memory 620 may store, for example, an image of the running operating system (which may include the kernel), device drivers, I/O configuration, etc., executing applications, as well as other data. System memory 620 includes the local storage units of one or more of the SPEs, which are mapped to a region of system memory 620. For example, local storage 659 may be mapped to mapped region 635, local storage 679 may be mapped to mapped region 640, and local storage 699 may be mapped to mapped region 642. PU 610 and the SPEs communicate with each other and system memory 620 through bus 617 that is configured to pass data between these devices.

The MMUs are responsible for transferring data between an SPU's local store and the system memory. In one embodiment, an MMU includes a direct memory access (DMA) controller configured to perform this function. PU 610 may program the MMUs to control which memory regions are available to each of the MMUs. By changing the mapping available to each of the MMUs, the PU may control which SPU has access to which region of system memory 620. In this manner, the PU may, for example, designate regions of the system memory as private for the exclusive use of a particular SPU. In one embodiment, the SPUs' local stores may be accessed by PU 610 as well as by the other SPUs using the memory map. In one embodiment, PU 610 manages the memory map for the common system memory 620 for all the SPUs. The memory map table may include PU 610's L2 Cache 615, system memory 620, as well as the SPUs' shared local stores.

In one embodiment, the SPUs process data under the control of PU 610. The SPUs may be, for example, digital signal processing cores, microprocessor cores, micro controller cores, etc., or a combination of the above cores. Each one of the local stores is a storage area associated with a particular SPU. In one embodiment, each SPU can configure its local store as a private storage area, a shared storage area, or an SPU may configure its local store as a partly private and partly shared storage.

For example, if an SPU requires a substantial amount of local memory, the SPU may allocate 100% of its local store to private memory accessible only by that SPU. If, on the other hand, an SPU requires a minimal amount of local memory, the SPU may allocate 10% of its local store to private memory and the remaining 90% to shared memory. The shared memory is accessible by PU 610 and by the other SPUs. An SPU may reserve part of its local store in order for the SPU to have fast, guaranteed memory access when performing tasks that require such fast access. The SPU may also reserve some of its local store as private when processing sensitive data, as is the case, for example, when the SPU is performing encryption/decryption.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
sending a Just-in-Time (JIT) compilation request from a first process running on a first processor included in a plurality of heterogeneous processors on a computer system to a JIT compiler running on a second processor included in the plurality of heterogeneous processors, wherein the first processor is based on a first instruction set architecture (ISA) and the second processor is based on a second ISA;
in response to the request, reading, by the JIT compiler, a plurality of non-compiled statements from a shared memory accessible from both the first and second processors;
compiling the non-compiled statements into one or more compiled segments of executable code; and
storing the compiled segments of executable code in the shared memory.

2. The method of claim 1 wherein the non-compiled statements are compiled into a plurality of executable code segments, the method further comprising:
compiling at least one of the segments into executable code complying with the first ISA (first segments), and compiling at least one of the segments into executable code complying with the second ISA (second segments);
running a second process on one of the plurality of heterogeneous processors that is based on the second ISA, wherein the second process performs steps including:
reading the second segments from the shared memory;
executing the executable code included in the second segments; and
signaling the first process.

3. The method of claim 2 further comprising:
generating synchronization code included in the compiled code for one or more of the first segments;
notifying the first process that at least one of the first segments is ready for execution;
receiving, at the first process, the notification, wherein the first process performs steps including:
reading the first segments from the shared memory;
executing the executable code included in the first segments;
receiving one or more signals from the second process; and
synchronizing the execution of the first segments with the execution of the second segments based on the received signals.

4. The method of claim 1 wherein a plurality of segments of executable code complying with the first ISA are compiled, the method further comprising:
sending a notification from the JIT compiler to the first upon compilation of each of the segments;
receiving the notifications at the first process, wherein, for each received notification, the first process performs steps including:
reading the executable instructions from an address space in the shared memory corresponding to the received notification; and
executing the executable instructions read from the address space.

5. The method of claim 1 wherein a plurality of segments of executable code are compiled, the method further comprising:
analyzing, at the JIT compiler, the non-compiled statements; and
determining, based on the analysis, the number of segments of executable code included in the plurality of segments.

6. The method of claim 5 further comprising:
identifying, based on the analysis, one or more segments for execution by the first process; and
identifying, based on the analysis, one or more segments for execution by a second process running on a processor included in the plurality of heterogeneous processors based on the second ISA.

7. The method of claim 1 wherein the non-compiled statements are bytecode.

8. An information handling system comprising:
a plurality of heterogeneous processors, wherein the plurality of heterogeneous processors includes a first processor type that utilizes a first instruction set architecture (ISA) and a second processor type that utilizes a second instruction set architecture (ISA);
a local memory corresponding to each of the plurality of heterogeneous processors;
a shared memory accessible by the heterogeneous processors;
a broadband bus interconnecting the plurality of heterogeneous processors and the shared memory;
one or more nonvolatile storage devices accessible by the heterogeneous processors; and
a first set of instructions running a first process on a first processor from the plurality of heterogeneous processors that utilizes the first ISA, and a second set of instructions running a JIT compiler on a second processor from the plurality of heterogeneous processors that utilizes the second ISA, wherein the first and second processors execute the sets of instructions in order to perform actions of:
sending JIT compilation request from the first process to the JIT compiler;
in response to the request, reading, by the JIT compiler, a plurality of non-compiled statements from the shared memory;
compiling, by the JIT compiler, the non-compiled statements into one or more compiled segments of executable code; and
storing the compiled segments of executable code in the shared memory.

9. The information handling system of claim 8 wherein the non-compiled statements are compiled into a plurality of executable code segments, the information handling system further comprising instructions in order to perform actions of:
compiling at least one of the segments into executable code complying with the first ISA (first segments), and compiling at least one of the segments into executable code complying with the second ISA (second segments);
running a second process on one of the plurality of heterogeneous processors that is based on the second ISA, wherein the second process performs steps including:
reading the second segments from the shared memory;
executing the executable code included in the second segments; and
signaling the first process.

10. The information handling system of claim 9 further comprising instructions in order to perform actions of:
generating synchronization code included in the compiled code for one or more of the first segments;
notifying the first process that at least one of the first segments is ready for execution;
receiving, at the first process, the notification, wherein the first process performs steps including:
reading the first segments from the shared memory;
executing the executable code included in the first segments;
receiving one or more signals from the second process; and
synchronizing the execution of the first segments with the execution of the second segments based on the received signals.

11. The information handling system of claim 8 wherein a plurality of segments of executable code complying with the first ISA are compiled, the information handling system further comprising instructions in order to perform actions of:
sending a notification from the JIT compiler to the first upon compilation of each of the segments;
receiving the notifications at the first process, wherein, for each received notification, the first process performs steps including:
reading the executable instructions from an address space in the shared memory corresponding to the received notification; and
executing the executable instructions read from the address space.

12. The information handling system of claim 8 wherein a plurality of segments of executable code are compiled, the information handling system further comprising instructions in order to perform actions of:
analyzing, at the JIT compiler, the non-compiled statements; and
determining, based on the analysis, the number of segments of executable code included in the plurality of segments.

13. The information handling system of claim 12 further comprising instructions in order to perform actions of:
identifying, based on the analysis, one or more segments for execution by the first process; and
identifying, based on the analysis, one or more segments for execution by a second process running on a processor included in the plurality of heterogeneous processors based on the second ISA.

14. A computer program product stored in a computer readable medium, comprising functional descriptive material that, when executed by a data processing system, causes the data processing system to perform actions that include:
sending a Just-in-Time (JIT) compilation request from a first process running on a first processor included in a plurality of heterogeneous processors on a computer system to a JIT compiler running on a second processor included in the plurality of heterogeneous processors, wherein the first processor is based on a first instruction set architecture (ISA) and the second processor is based on a second ISA;
in response to the request, reading, by the JIT compiler, a plurality of non-compiled statements from a shared memory accessible from both the first and second processors;
compiling the non-compiled statements into one or more compiled segments of executable code; and
storing the compiled segments of executable code in the shared memory.

15. The computer program product of claim 14 wherein the non-compiled statements are compiled into a plurality of executable code segments, wherein the functional descriptive material further performs actions that include:
compiling at least one of the segments into executable code complying with the first ISA (first segments), and compiling at least one of the segments into executable code complying with the second ISA (second segments);
running a second process on one of the plurality of heterogeneous processors that is based on the second ISA, wherein the second process performs steps including:
reading the second segments from the shared memory;
executing the executable code included in the second segments; and
signaling the first process.

16. The computer program product of claim 15, wherein the functional descriptive material further performs actions that include:
generating synchronization code included in the compiled code for one or more of the first segments;
notifying the first process that at least one of the first segments is ready for execution;
receiving, at the first process, the notification, wherein the first process performs steps including:
reading the first segments from the shared memory;
executing the executable code included in the first segments;
receiving one or more signals from the second process; and
synchronizing the execution of the first segments with the execution of the second segments based on the received signals.

17. The computer program product of claim 14 wherein a plurality of segments of executable code complying with the first ISA are compiled, and wherein the functional descriptive material further performs actions that include:
sending a notification from the JIT compiler to the first upon compilation of each of the segments;
receiving the notifications at the first process, wherein, for each received notification, the first process performs steps including:
reading the executable instructions from an address space in the shared memory corresponding to the received notification; and
executing the executable instructions read from the address space.

18. The computer program product of claim 14 wherein a plurality of segments of executable code are compiled, and wherein the functional descriptive material further performs actions that include:
analyzing, at the JIT compiler, the non-compiled statements; and
determining, based on the analysis, the number of segments of executable code included in the plurality of segments.

19. The computer program product of claim 18, wherein the functional descriptive material further performs actions that include:
identifying, based on the analysis, one or more segments for execution by the first process; and
identifying, based on the analysis, one or more segments for execution by a second process running on a processor included in the plurality of heterogeneous processors based on the second ISA.

20. The computer program product of claim 14 wherein the non-compiled statements are bytecode.
